(19) United States
(12) Patent Application Publication
(10) Pub. No.: US 2022/0320681 A1
(43) Pub. Date: Oct. 6, 2022

(54) NONAQUEOUS ELECTROLYTE SECONDARY BATTERY SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Takahiro MATSUO, Niihama-shi (JP); Atsuhiro TAKATA, Osaka (JP); Kenta AOKI, Niihama-shi (JP); Yuki YONEGUCHI, Niihama-shi (JP)

(21) Appl. No.: 17/706,845

(22) Filed: Mar. 29, 2022

(30) Foreign Application Priority Data
Mar. 30, 2021 (JP) 2021-058380

(51) Int. Cl. H01M 50/417

(52) U.S. Cl. CPC H01M 50/417

(57) ABSTRACT

A nonaqueous electrolyte secondary battery separator having excellent impact resistance contains a polyolefin porous film. The nonaqueous electrolyte secondary battery separator has a (200) plane peak area ratio R of not less than 0.15; the (200) plane peak area ratio R is a ratio of a peak area I(200) of a diffraction peak on a (200) plane to a peak area I(110) of a diffraction peak on a (110) plane and is calculated from a diffraction intensity profile obtained by wide-angle X-ray diffraction that is carried out by irradiating a surface of the nonaqueous electrolyte secondary battery separator with an X-ray from a direction vertical to the surface of the nonaqueous electrolyte secondary battery separator.

This Nonprovisional application claims priority under 35 U.S.C. § 119 on Patent Application No. 2021-058380 filed in Japan on Mar. 30, 2021, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

Examples of a separator for use in such a nonaqueous electrolyte secondary battery include: a separator consisting of a porous film, disclosed in Patent Literature 1, containing polyolefin as a main component; and a separator consisting of a laminate including the porous film and a heat-resistant resin layer formed on at least one surface of the porous film.

### CITATION LIST

### Patent Literature

[Patent Literature 1]

Japanese Patent Application Publication Tokukai No. 2006-273987

### SUMMARY OF INVENTION

### Technical Problem

However, the conventional separator described above has room for improvement in impact resistance.

An object of an aspect of the present invention is to provide a nonaqueous electrolyte secondary battery separator that has excellent impact resistance. More specifically, the object of the aspect of the present invention is to provide a nonaqueous electrolyte secondary battery separator that, by virtue of its excellent impact resistance, makes it possible to prevent a nonaqueous electrolyte secondary battery from causing ignition due to an impact from outside and enhance safety of the nonaqueous electrolyte secondary battery.

### Solution to Problem

As a result of diligent research, the inventors of the present invention arrived at the present invention after discovering that a nonaqueous electrolyte secondary battery separator containing a polyolefin crystal the orientation of which is suppressed in a specific range has excellent impact resistance.

The present invention includes the following aspects.

[1] A nonaqueous electrolyte secondary battery separator including:

a polyolefin porous film,

the nonaqueous electrolyte secondary battery separator having a (200) plane peak area ratio R of not less than 0.15, the (200) plane peak area ratio R being calculated, from a diffraction intensity profile obtained by wide-angle X-ray diffraction (WAXD) measurement, by the following formula (1):

(200) plane peak area ratio R=I(200)/I(110) (1)

wherein the WAXD is carried out by irradiating a surface of the nonaqueous electrolyte secondary battery separator with an X-ray from a direction vertical to the surface of the nonaqueous electrolyte secondary battery separator, I(110) is a peak area of a diffraction peak on a (110) plane of the diffraction intensity profile, and I(200) is a peak area of a diffraction peak on a (200) plane of the diffraction intensity profile.

[2] The nonaqueous electrolyte secondary battery separator described in [1], further including:

a porous layer containing a resin,

the porous layer being formed on one surface or on both surfaces of the polyolefin porous film.

[3] The nonaqueous electrolyte secondary battery separator described in [2], wherein the resin is at least one kind of resin selected from the group consisting of polyolefins, (meth)acrylate-based resins, fluorine-containing resins, polyamide-based resins, polyester-based resins, and water-soluble polymers.

[4] The nonaqueous electrolyte secondary battery separator described in [2] or [3], wherein the resin is an aramid resin.

[5] The nonaqueous electrolyte secondary battery separator described in any one of [1] to [4], wherein the polyolefin porous film has a puncture strength of not less than 5.0 N.

[6] A nonaqueous electrolyte secondary battery member including:

a positive electrode;

the nonaqueous electrolyte secondary battery separator described in any one of [1] to [5]; and

a negative electrode,

the positive electrode, the nonaqueous electrolyte secondary battery separator, and the negative electrode being arranged in this order.

[7] A nonaqueous electrolyte secondary battery including:

the nonaqueous electrolyte secondary battery separator according to any one of [1] to [5].

### Advantageous Effects of Invention

A nonaqueous electrolyte secondary battery separator in accordance with an embodiment of the present invention yields the effect of having excellent impact resistance and making it possible to prevent a nonaqueous electrolyte secondary battery from causing ignition due to an impact from outside and enhance safety of the nonaqueous electrolyte secondary battery.

### BRIEF DESCRIPTION OF DRAWINGS

FIG. 1 is a diagram illustrating a diffraction intensity profile obtained in Example 1.

FIG. 2 is a diagram illustrating a diffraction intensity profile obtained in Example 2.

FIG. 3 is a diagram illustrating a diffraction intensity profile obtained in Example 3.

FIG. 4 is a diagram illustrating a diffraction intensity profile obtained in Example 4.

FIG. 5 is a diagram illustrating a diffraction intensity profile obtained in Comparative Example 1.

FIG. 6 is a diagram illustrating a diffraction intensity profile obtained in Comparative Example 2.

### DESCRIPTION OF EMBODIMENTS

The following description will discuss embodiments of the present invention. Note, however, that the present invention is not limited to these embodiments. The present invention is not limited to arrangements described below, but may be altered in various ways by a skilled person within the scope of the claims. The present invention also encompasses, in its technical scope, any embodiment derived by combining technical means disclosed in differing embodiments. Any numerical range expressed as “A to B” herein means “not less than A and not more than B” unless otherwise stated.

Herein, the term “machine direction” (MD) refers to a direction which a polyolefin resin composition in sheet form, a primary sheet, a secondary sheet, and a porous film are conveyed in the below-described method of producing the porous film. The term “transverse direction” (TD) refers to a direction which is (i) perpendicular to the MD and (ii) parallel to the surface of the polyolefin resin composition in sheet form, the surface of the primary sheet, the surface of the secondary sheet, and the surface of the porous film.

### Embodiment 1: Nonaqueous Electrolyte Secondary Battery Separator

1. Nonaqueous Electrolyte Secondary Battery Separator

A nonaqueous electrolyte secondary battery separator in accordance with an embodiment of the present invention is a nonaqueous electrolyte secondary battery separator including a polyolefin porous film, the nonaqueous electrolyte secondary battery separator having a (200) plane peak area ratio R of not less than 0.15, the (200) plane peak area ratio R being calculated, from a diffraction intensity profile obtained by wide-angle X-ray diffraction (WAXD) measurement, by the following formula (1):

(200) plane peak area ratio R=I(200)/I(110) (1)

wherein the WAXD is carried out by irradiating a surface of the nonaqueous electrolyte secondary battery separator with an X-ray from a direction vertical to the surface of the nonaqueous electrolyte secondary battery separator, I(110) is a peak area of a diffraction peak on a (110) plane of the diffraction intensity profile, and I(200) is a peak area of a diffraction peak on a (200) plane of the diffraction intensity profile.

The nonaqueous electrolyte secondary battery separator in accordance with an embodiment of the present invention includes a polyolefin porous film. Hereinafter, the polyolefin porous film may also be referred to simply as a “porous film”.

The nonaqueous electrolyte secondary battery separator in accordance with an embodiment of the present invention may be a nonaqueous electrolyte secondary battery separator that consists of the porous film. The nonaqueous electrolyte secondary battery separator in accordance with an embodiment of the present invention may be a nonaqueous electrolyte secondary battery separator that is a laminate including the porous film and a porous layer (described later).

Hereinafter, a nonaqueous electrolyte secondary battery separator that is the laminate (described later) may also be referred to as a “nonaqueous electrolyte secondary battery laminated separator”.

The nonaqueous electrolyte secondary battery separator in accordance with an embodiment of the present invention may, as necessary, include, in addition to the porous film and the porous layer, another porous layer that is a publicly known porous layer such as a heat-resistant layer, an adhesive layer, and/or a protective layer as described later.

The porous film contains a polyolefin-based resin. Typically, the porous film contains the polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the entire amount of materials of which the porous film is made.

The porous film has many pores connected to one another. This allows a gas and a liquid to pass through the porous film from one side to the other side.

The nonaqueous electrolyte secondary battery separator in accordance with an embodiment of the present invention has the (200) plane peak area ratio R of not less than 0.15.

The (200) plane peak area ratio R is a parameter representing crystal orientation of the polyolefin which is a main component of the polyolefin porous film. A high (200) plane peak area ratio R means that the crystal orientation of the polyolefin decreases and that the exhibition of crystal anisotropy of the polyolefin is suppressed.

Since the nonaqueous electrolyte secondary battery separator in accordance with an embodiment of the present invention has the (200) plane peak area ratio R of not less than 0.15, the degree of the orientation of the nonaqueous electrolyte secondary battery separator is low. Here, the nonaqueous electrolyte secondary battery separator having a low degree of the orientation is such that a crystalline structure of the polyolefin has high flexibility of being changed by an external force or the like. Thus, when an impact is applied from outside, the polyolefin porous film in accordance with an embodiment of the present invention tends to maintain the crystalline structure of the polyolefin and is less likely to be damaged. Therefore, the nonaqueous electrolyte secondary battery separator in accordance with an embodiment of the present invention has excellent impact resistance.

A higher (200) plane peak area ratio R of the nonaqueous electrolyte secondary battery separator in accordance with an embodiment of the present invention is preferable since such a (200) plane peak area ratio R allows the nonaqueous electrolyte secondary battery separator to exhibit excellent impact resistance. Specifically, the (200) plane peak area ratio R is preferably not less than 0.15 and more preferably not less than 0.16. Further, an upper limit of the (200) plane peak area ratio R is not particularly limited and is, for example, not more than 0.20.

The (200) plane peak area ratio R can be found based on a diffraction intensity profile obtained by wide-angle X-ray diffraction (WAXD) measurement. The (200) plane peak area ratio R is measured by, for example, a method indicated by (1) to (5) below.

(1) Wide-angle X-ray diffraction (WAXD) measurement is carried out by irradiating a surface of a nonaqueous electrolyte secondary battery separator with an X-ray from a direction vertical to the surface of the nonaqueous electrolyte secondary battery separator, so that a WAXD diagram is obtained. The above phrase “irradiating a surface of a nonaqueous electrolyte secondary battery separator with an X-ray from a direction vertical to the surface of the nonaqueous electrolyte secondary battery separator” means irradiating the surface of the nonaqueous electrolyte secondary battery separator with an X-ray such that an angle (angle of irradiation of the surface with the X-ray) between the X-ray emitted from an X-ray irradiation device (for example, NANO-Viewer manufactured by Rigaku Corporation (described later)) and the surface of the nonaqueous electrolyte secondary battery separator is 90 degrees.

(2) From the WAXD diagram, for a peak on a (110) plane of polyolefin, an azimuthal profile is calculated assuming that a horizontal direction is at an azimuth angle β=0 degree.

(3) A diffraction intensity profile with respect to the diffraction angle 2θ is calculated at an azimuth angle β of ±5 degrees around the most intense peak that appears in the vicinity of β=0 degree in the azimuthal profile.

(4) Calculated from the diffraction intensity profile are areas I(110) and I(200) of peaks on (110) and (200) planes of polyolefin that is a main component of the polyolefin porous film in the nonaqueous electrolyte secondary battery separator.

(5) The areas I(110) and I(200) thus calculated are used to calculate the (200) plane peak area ratio R based on the following formula (1):

(200) plane peak area ratio R=I(200)/I(110) (1)

The positions of the peaks on the (110) and (200) planes vary depending on, for example, the type of the polyolefin. For example, when the polyolefin is polyethylene, the peak on the (110) plane is detected in the vicinity of diffraction angle 2θ of 21 degrees, and the peak on the (200) plane is detected in the vicinity of diffraction angle 2θ of 24.5 degrees.

Here, in the diffraction intensity profile, a peak derived from the polyolefin that is a main component of the polyolefin porous film is observed. In contrast, for example, peaks derived from the porous layer and the like, which are members other than the polyolefin porous film, are not observed. That is, the porous layer and the like do not influence the measurement of the (200) plane peak area ratio R.

Thus, even when the nonaqueous electrolyte secondary battery separator in accordance with an embodiment of the present invention is a nonaqueous electrolyte secondary battery laminated separator, the (200) plane peak area ratio R serves as a parameter representing properties of the polyolefin porous film.

Therefore, both when the nonaqueous electrolyte secondary battery separator in accordance with an embodiment of the present invention consists of a porous film and when the nonaqueous electrolyte secondary battery separator in accordance with an embodiment of the present invention is a nonaqueous electrolyte secondary battery laminated separator, it is possible to measure the (200) plane peak area ratio R by the method described above.

The porous film has an MD breaking elongation ratio of preferably not less than 20% GL (Gauge Length), and more preferably not less than 30% GL. An upper limit of the MD breaking elongation ratio is not particularly limited, and normally can be 300% GL or less. The MD breaking elongation ratio is measured by a method in conformance with the JIS K7127 standard.

Here, the MD breaking elongation ratio is expressed as a ratio (%) of (i) the length by which the porous film has elongated in the MD at the time the porous film breaks when carrying out a predetermined operation to (ii) the length in the MD of the porous film prior to carrying out the operation. Note that the predetermined operation is an operation to elongate the porous film in the MD.

The porous film has a TD breaking elongation ratio of preferably not less than 50% GL, and more preferably not less than 60% GL. An upper limit of the TD breaking elongation ratio is not particularly limited, and normally can be 300% GL or less. The TD breaking elongation ratio is measured by a method in conformance with the JIS K7127 standard.

The TD breaking elongation ratio of the porous film can be expressed in the same manner as the MD breaking elongation ratio of the porous film. That is, the TD breaking elongation ratio is expressed as a ratio (%) of (i) the length by which the porous film has elongated in the TD at the time the porous film breaks when carrying out an operation to elongate the porous film in the TD to (ii) the length in the TD of the porous film prior to carrying out the operation.

However, in a sheet-type porous film, i.e., a porous film which has been processed to a predetermined size, it can be difficult to distinguish between the TD and the MD. In such a case, if the sheet-type porous film is rectangular, measurements can be carried out to determine (i) the breaking elongation ratio when the porous film is elongated in a direction parallel to one of the sides of the rectangle and (ii) the breaking elongation ratio when the porous film is elongated in a direction perpendicular to that side of the rectangle. Because a porous film typically has less strength with respect to elongation in the MD, out of the two breaking elongation ratios, the smaller value is considered to be the value of the MD breaking elongation ratio, and the larger value is considered to be the value of the TD breaking elongation ratio.

If the TD and MD of a porous film cannot be distinguished and the porous film is not rectangular in shape, the porous film can be elongated in a plurality of discretionarily chosen directions, and a breaking elongation ratio can be measured for each of the directions of elongation. Thereafter, out of the breaking elongation ratios measured, the smallest value is considered to be the value of the MD breaking elongation ratio. A direction perpendicular to the elongation direction used in the measurement of the MD breaking elongation ratio is considered to be the TD, and the breaking elongation ratio in that direction is considered to be the TD breaking elongation ratio. Note that in the present specification, the “shape” of a porous film refers to the shape of a surface of the porous film which surface is perpendicular to the thickness-wise direction of the porous film.

The porous film has a film thickness of 4 μm to 40 μm. The film thickness of the porous film is preferably 5 μm to 20 μm. The porous film having a film thickness of not less than 4 μm makes it possible to sufficiently prevent an internal short circuit in a battery. The porous film having a film thickness of not more than 40 μm makes it possible to prevent the nonaqueous electrolyte secondary battery from being large in size.

The porous film having excessively large film thickness, for example, a film thickness exceeding 40 μm makes it possible to obtain a certain degree of impact resistance due to such a film thickness. However, such a configuration cannot meet a recent demand for thinner nonaqueous electrolyte secondary battery separators.

In contrast, the nonaqueous electrolyte secondary battery separator in accordance with an embodiment of the present invention, even though it has a film thickness of, for example, 4 μm to 40 μm, makes it possible to exhibit sufficient impact resistance since it is configured to have the (200) plane peak area ratio R of not less than 0.15.

The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000, because such a resin improves the strength of the porous film and the nonaqueous electrolyte secondary battery separator including the porous film.

Further, in order that the (200) plane peak area ratio R is controlled to be not less than 0.15, the main component of the polyolefin-based resin is preferably polyolefin having a weight-average molecular weight of not less than 500,000. Note, here, that the “main component” means a component that accounts for not less than 50% by weight of the total weight of the polyolefin-based resin.

The polyolefin-based resin is not limited to a particular one, and possible examples encompass, for example, homopolymers and copolymers which are each obtained by polymerizing one or more monomers selected from monomers such as ethylene, propylene, 1-butene, 4-methyl-1-pentene, and 1-hexene.

Examples of such homopolymers encompass polyethylene, polypropylene, and polybutene. Examples of such copolymers encompass an ethylene-propylene copolymer.

Among the above examples, polyethylene is more preferable because use of polyethylene makes it possible to prevent a flow of an excessively large electric current at a lower temperature in the nonaqueous electrolyte secondary battery separator. Examples of the polyethylene encompass low-density polyethylene, high-density polyethylene, linear polyethylene (ethylene-α-olefin copolymer), and ultra-high molecular weight polyethylene having a weight-average molecular weight of not less than 1,000,000. Among these examples, the ultra-high molecular weight polyethylene having a weight-average molecular weight of not less than 1,000,000 is more preferable.

The polyolefin-based resin may contain polyolefin in which the number of long chain branch points per molecule is preferably 20 or less, and more preferably 10 or less. The number of long chain branch points is, for example, a value calculated from a conformation plot obtained using GPC-MALS. The conformation plot is a logarithmic plot of molecular radius versus molecular weight.

The polyolefin porous film typically has a weight per unit area of preferably 4 g/m² to 20 g/m², and more preferably 5 g/m² to 12 g/m², so as to allow a nonaqueous electrolyte secondary battery to have a higher weight energy density and a higher volume energy density.

The polyolefin porous film has an air permeability of preferably 110 sec/100 mL to 200 sec/100 mL, and more preferably 110 sec/100 mL to 190 sec/100 mL, in terms of Gurley values, because such an air permeability enables a sufficient ion permeability.

The porous film has a puncture strength of preferably not less than 5.0 N, more preferably not less than 5.3 N, and even more preferably not less than 5.5 N. The porous film having a puncture strength of not less than 5.0 N means that the nonaqueous electrolyte secondary battery separator in accordance with an embodiment of the present invention has a sufficiently high strength. Thus, the puncture strength of not less than 5.0 N is preferable because such a puncture strength makes it possible to achieve more excellent impact resistance. The puncture strength can be measured by the following method:

(i) The porous film is fixed on an upper surface of a stage with a washer having a diameter of 12 mm, and thereafter a pin (diameter of 1 mm; tip radius of 0.5R) is thrust into the porous film at a speed of 10 mm/sec to a depth of 10 mm. Note, here, that the stage is not limited in its shape, material, etc., as long as the upper surface of the stage is flat.

(ii) The maximum stress (gf) occurring when the pin is thrust into the porous film in (i) is measured, and the measured value is considered to be the puncture strength of the porous film.

The porous film has a porosity of preferably 20% by volume to 80% by volume, and more preferably 30% by volume to 75% by volume, so as to (i) retain a larger amount of electrolyte and (ii) obtain the function of reliably preventing (shutting down) a flow of an excessively large electric current at a lower temperature.

The pore diameter of each pore of the porous film is preferably not more than 0.3 μm and more preferably not more than 0.14 μm, from the viewpoint of (i) achieving sufficient ion permeability and (ii) preventing particles which constitute an electrode from entering the polyolefin porous film.

2. Method of Producing Polyolefin Porous Film

A method of producing a polyolefin porous film in an embodiment of the present invention is not limited to a particular method, and specific examples encompass a method including the following steps (A) to (D):

(A) a step of obtaining a polyolefin resin composition by melting and kneading, in a kneader, a polyolefin-based resin and optionally an additive such as a pore forming agent;

(B) a step of obtaining a primary sheet by (i) extruding, from a T-die of an extruder, the polyolefin resin composition thus obtained and (ii) forming the polyolefin resin composition into a sheet by stretching the polyolefin resin composition in a first direction while cooling the polyolefin resin composition;

(C) a step of obtaining a secondary sheet by stretching the primary sheet in a second direction differing from the first direction;

(D) a step of stretching the secondary sheet in the second direction differing from the first direction, while causing the secondary sheet to shrink in the first direction.

In the step (A), the polyolefin-based resin is used in an amount of preferably 6% by weight to 45% by weight, and more preferably 9% by weight to 36% by weight, with respect to 100% by weight of the polyolefin resin composition to be obtained. Further, the main component of the polyolefin has a weight-average molecular weight of not less than 500,000.

The first direction is preferably the MD. Further, the second direction is preferably the TD.

The pore forming agent is not limited to a particular one, and possible examples encompass plasticizers and inorganic bulking agents. The inorganic bulking agents are not limited to particular ones. Examples of the inorganic bulking agents encompass inorganic fillers and, specifically, calcium carbonate. The plasticizers are not limited to particular ones. Examples of the plasticizers encompass low molecular weight hydrocarbons such as liquid paraffin.

Examples of the additive encompass publicly known additives other than the pore forming agent, which additives can be optionally used to an extent that does not cause a deterioration in effects of the present invention. Examples of the publicly known additives encompass antioxidants.

In the step (B), the method of obtaining the primary sheet is not limited to a particular method. The primary sheet may be obtained by a sheet forming method such as inflation processing, calendering, T-die extrusion, or a Scaif method.

A sheet formation temperature in the sheet forming method, such as a T-die extrusion temperature in T-die extrusion, is preferably 200° C. to 280° C., and more preferably 220° C. to 260° C.

Examples of methods for obtaining the primary sheet with a high degree of precision in terms of thickness encompass a method of roll-molding the polyolefin resin composition with use of a pair of rotational molding tools whose surface temperatures have been adjusted to be higher than the melting point of the polyolefin-based resin contained in the polyolefin resin composition. The surface temperature of the rotational molding tools is preferably not less than 5° C. higher than the melting point of the polyolefin-based resin. An upper limit of the surface temperature is preferably not more than 30° C. higher than the melting point of the polyolefin-based resin, and more preferably not more than 20° C. higher than the melting point of the polyolefin-based resin.

Examples of the pair of rotational molding tools encompass rollers and belts. The respective circumferential velocities of the two rotational molding tools do not necessarily have to be identical. The respective circumferential velocities need only be within approximately 5% of each other. The primary sheet may include a plurality of individual sheets obtained via the above sheet forming method which individual sheets have been laminated together.

When roll-molding the polyolefin resin composition with use of a pair of rotational molding tools, the polyolefin resin composition discharged in strand form may be introduced between the rotational molding tools directly from the extruder, or may first be formed into pellets.

A stretch ratio employed in the step (B) is preferably 1.1 times to 1.9 times, and more preferably 1.2 times to 1.8 times. A stretching temperature employed in the step (B) is preferably 120° C. to 160° C., and more preferably 130° C. to 155° C.

The method of cooling the polyolefin resin composition in the step (B) may be, for example, a method of bringing the polyolefin resin composition into contact with a cooling medium such as cool air or coolant water, or a method of bringing the polyolefin resin composition into contact with a cooling roller. The method of involving contact with a cooling roller is preferable.

The first direction in the step (B) is preferably the MD. Setting the first direction to be the MD is preferable since doing so makes it possible, in a “relaxation operation” (described later), to improve the strength of the porous film with respect to elongation in the MD (which is normally the direction of least strength) and to efficiently improve the strength of the entire porous film with respect to elongation.

If the polyolefin resin composition and the primary sheet contain a pore forming agent, the method of producing the polyolefin porous film includes a step of removing the pore forming agent by cleaning the stretched sheet with use of cleaning liquid. The step of removing the pore forming agent is performed between the steps (B) and (C) or after the step (C).

The cleaning liquid is not limited to a particular one, as long as it is a solvent capable of removing the pore forming agent. Examples of the cleaning liquid encompass an aqueous hydrochloric acid solution, heptane, and dichloromethane.

In the step (C), the stretching temperature employed when performing stretching in the second direction is preferably 80° C. to 140° C., and more preferably 90° C. to 130° C. Further, the stretch ratio employed when performing stretching in the second direction is preferably 2 times to 12 times, and more preferably 3 times to 10 times.

In the step (D), carrying out an operation to shrink the secondary sheet in the first direction when stretching the secondary sheet in the second direction makes it possible to improve impact resistance of the obtained porous film.

In the step (D), the step of starting stretching the secondary sheet in the second direction and the step of shrinking the secondary sheet in the first direction may be carried out simultaneously. Alternatively, the steps may be carried out such that either one of the steps is carried out first, and then the other step is carried out. However, it is preferable to carry out the steps simultaneously or to carry out first the step of starting stretching the secondary sheet in the second direction. In this case, stretching the secondary sheet in the second direction causes a shrinkage force in the first direction to act on the secondary sheet. This makes it possible to shrink the secondary sheet without wrinkles.

In the step (D), the stretching temperature employed when causing the secondary sheet to shrink in the first direction is preferably 80° C. to 140° C., and more preferably 90° C. to 130° C. Further, the stretch ratio employed when stretching the secondary sheet in the second direction is preferably 1.2 times to 2 times, and more preferably 1.3 times to 1.5 times. A shrinkage ratio employed when shrinking the secondary sheet in the first direction is preferably 10% to 50%, and more preferably 20% to 40%.

Here, in the step (D), shrinking the secondary sheet in the first direction makes it possible to improve tensile elongation of the obtained porous film in the first direction and makes it possible to suppress the exhibition of crystal anisotropy of polyolefin in the porous film.

Further, it is preferable to employ an aspect such that a stretch ratio at which the secondary sheet is stretched in the second direction in the step (D) is as low as possible as compared to the stretch ratio at which the primary sheet is stretched in the second direction in the step (C) (hereinafter referred to as “aspect A”). For example, it is preferable that the stretch ratio in the step (D) is controlled to be a stretch ratio to such an extent that no wrinkles are generated in the porous film to be obtained. This makes it possible to control the crystal orientation of the polyolefin in the porous film such that the (200) plane peak area ratio R is not less than 0.15.

In fact, in Examples 1 to 4 (described later) that satisfy the aspect A, the nonaqueous electrolyte secondary battery separators have the (200) plane peak area ratio R that is as high as not less than 0.15, and the results of the simple impact test that the nonaqueous electrolyte secondary battery separators in Examples 1 to 4 have films which are less likely to break are obtained.

Note that carrying out only the step (D) without carrying out the step (C) improves the tensile elongation of the obtained porous film in the first direction, but leads to the exhibition of the crystal anisotropy of polyolefin in the obtained porous film exhibits and enhances the crystal orientation of the polyolefin.

For example, in Comparative Example 2 described later, a nonaqueous electrolyte secondary battery separator including a porous film obtained by carrying out only the step (D) without carrying out the step (C) has the (200) plane peak area ratio R that is as low as less than 0.15. Further, for the nonaqueous electrolyte secondary battery separator in Comparative Example 2, the result of the simple impact test that such a nonaqueous electrolyte secondary battery separator has a film which is more likely to break is obtained.

3. Porous Layer

The nonaqueous electrolyte secondary battery separator in accordance with an embodiment of the present invention may be a nonaqueous electrolyte secondary battery laminated separator that includes the polyolefin porous film and a porous layer formed on one surface or on both surfaces of the polyolefin porous film.

The porous layer is a resin layer containing a resin. The porous layer is preferably a heat-resistant layer or an adhesive layer. It is preferable that the resin of which the porous layer is made be insoluble in the electrolyte of the battery and be electrochemically stable when the battery is in normal use.

If the porous layer is formed on one surface of the polyolefin porous film, the porous layer is preferably formed on a surface of the polyolefin porous film which surface faces a positive electrode of a nonaqueous electrolyte secondary battery to be produced, and more preferably on a surface of the polyolefin porous film which surface comes into contact with the positive electrode.

Examples of the resin encompass polyolefins, (meth)acrylate-based resins, fluorine-containing resins, polyamide-based resins, polyimide-based resins, polyester-based resins, rubbers, resins with a melting point or glass transition temperature of not lower than 180° C., water-soluble polymers, polycarbonate, polyacetal, and polyether ether ketone.

Of the above resins, polyolefins, (meth)acrylate-based resins, fluorine-containing resins, polyamide-based resins, polyester-based resins, and water-soluble polymers are preferable.

Preferable examples of the polyolefins encompass polyethylene, polypropylene, polybutene, and an ethylene-propylene copolymer.

Examples of the fluorine-containing resins encompass polyvinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

As the polyamide-based resins, aramid resins such as aromatic polyamides and wholly aromatic polyamides are preferable.

Specific examples of the aramid resins encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, a metaphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Among these aramid resins, poly(paraphenylene terephthalamide) is more preferable.

It is possible to use only one of the above resins, or two or more of the above resins in combination.

The porous layer may contain fine particles. The term “fine particles” herein means organic fine particles or inorganic fine particles generally referred to as a filler. The fine particles are preferably electrically insulating fine particles.

Examples of the organic fine particles encompass resin fine particles. Examples of the inorganic fine particles encompass fillers made of inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. It is possible to use only one type of the above fine particles, or two or more types of the above fine particles in combination.

The porous layer contains the fine particles in an amount of preferably 1% by volume to 99% by volume, and more preferably 5% by volume to 95% by volume, with respect to 100% by volume of the porous layer.

The porous layer has a thickness of preferably 0.5 μm to 15 μm per layer, and more preferably 2 μm to 10 μm per layer. Setting the thickness of the porous layer to be not less than 0.5 μm per layer makes it possible to sufficiently prevent an internal short circuit caused by, for example, breakage of the nonaqueous electrolyte secondary battery, and also to retain a sufficient amount of the electrolyte in the porous layer. Setting the thickness of the porous layer to be not more than 15 μm per layer makes it possible to reduce or prevent a decrease in a rate characteristic or cycle characteristic.

The weight per unit area of the porous layer is preferably 1 g/m² to 20 g/m² per layer and more preferably 4 g/m² to 10 g/m² per layer.

A volume per square meter of all component(s) contained in the porous layer is preferably 0.5 cm³ to 20 cm³ per layer, more preferably 1 cm³ to 10 cm³ per layer, and even more preferably 2 cm³ to 7 cm³ per layer.

For the purpose of achieving sufficient ion permeability, the porosity of the porous layer is preferably 20% by volume to 90% by volume, and more preferably 30% by volume to 80% by volume. In order for the nonaqueous electrolyte secondary battery laminated separator to have sufficient ion permeability, the pore diameter of each pore of the porous layer is preferably not more than 3 μm, and more preferably not more than 1 μm.

The nonaqueous electrolyte secondary battery laminated separator has a thickness of preferably 5.5 μm to 45 μm and more preferably 6 μm to 25 μm.

The nonaqueous electrolyte secondary battery laminated separator has an air permeability of preferably 100 sec/100 mL to 350 sec/100 mL and more preferably 100 sec/100 mL to 300 sec/100 mL, in terms of Gurley values.

The nonaqueous electrolyte secondary battery laminated separator has a puncture strength of preferably not less than 5.0 N, more preferably not less than 5.3 N, and even more preferably not less than 5.5 N. The puncture strength is measured using a method similar to that used for the porous film.

The nonaqueous electrolyte secondary battery separator in accordance with an embodiment of the present invention may include, as necessary, another porous layer other than the porous film and the porous layer, provided that the other porous layer does not prevent attainment of an object of an embodiment of the present invention. Examples of the other porous layer encompass publicly known porous layers such as a heat-resistant layer, an adhesive layer, and a protective layer.

4. Method of Producing Porous Layer and Nonaqueous Electrolyte Secondary Battery Laminated Separator

A method of producing the porous layer in an embodiment of the present invention and the nonaqueous electrolyte secondary battery laminated separator in accordance with an embodiment of the present invention may be, for example, a method involving: applying a coating solution to one or both surfaces of the porous film, the coating solution containing the resin contained in the porous layer; and depositing the porous layer by drying the coating solution.

The coating solution contains a resin to be contained in the porous layer. The coating solution may contain the above-described fine particles which may be contained in the porous layer. The coating solution can be prepared typically by (i) dissolving, in a solvent, the resin that can be contained in the porous layer and (ii) dispersing, in the solvent, the fine particles. The solvent in which the resin is to be dissolved is not limited to any particular one and also serves as a dispersion medium in which the fine particles are to be dispersed. Depending on the solvent, the resin may be an emulsion.

The coating solution may be formed by any method, provided that the coating solution can satisfy conditions, such as a resin solid content (resin concentration) and/or a fine particle amount, which are necessary for obtaining a desired porous layer.

A method of applying the coating solution to the porous film is not limited to any particular one. As the coating solution applying method, a conventionally publicly known method can be employed. Specific examples of such a method include a gravure coater method, a dip coater method, a bar coater method, and a die coater method.

### Embodiment 2: Nonaqueous Electrolyte Secondary Battery Member, Embodiment 3: Nonaqueous Electrolyte Secondary Battery

A nonaqueous electrolyte secondary battery member in accordance with Embodiment 2 of the present invention includes a positive electrode, the nonaqueous electrolyte secondary battery separator in accordance with Embodiment 1 of the present invention, and a negative electrode, the positive electrode, the nonaqueous electrolyte secondary battery separator, and the negative electrode being arranged in this order.

A nonaqueous electrolyte secondary battery in accordance with Embodiment 3 of the present invention includes the nonaqueous electrolyte secondary battery separator in accordance with Embodiment 1 of the present invention.

The nonaqueous electrolyte secondary battery can be, for example, a nonaqueous secondary battery that achieves an electromotive force through doping with and dedoping of lithium, and can include a nonaqueous electrolyte secondary battery member including (i) a positive electrode, (ii) the nonaqueous electrolyte secondary battery separator, and (iii) a negative electrode, the positive electrode, the nonaqueous electrolyte secondary battery separator, and the negative electrode being arranged in this order. Note that constituent elements of the nonaqueous electrolyte secondary battery other than the nonaqueous electrolyte secondary battery separator are not limited to those described below.

The nonaqueous electrolyte secondary battery is typically configured so that a battery element is enclosed in an exterior member, the battery element including (i) a structure in which the negative electrode and the positive electrode face each other and sandwich the nonaqueous electrolyte secondary battery separator and (ii) an electrolyte with which the structure is impregnated. The nonaqueous electrolyte secondary battery is particularly preferably a lithium-ion secondary battery. Note that the doping refers to occlusion, support, adsorption, or insertion, and refers to a phenomenon in which lithium ions enter an active material of an electrode (e.g., a positive electrode).

The nonaqueous electrolyte secondary battery member includes the nonaqueous electrolyte secondary battery separator. As such, the nonaqueous electrolyte secondary battery member brings about the effect of making it possible to produce a nonaqueous electrolyte secondary battery having excellent safety, for example, excellent safety against an impact from outside.

The nonaqueous electrolyte secondary battery includes the nonaqueous electrolyte secondary battery separator. As such, the nonaqueous electrolyte secondary battery brings about the effect of having excellent safety, for example, excellent safety against an impact from outside.

1. Positive Electrode

The positive electrode included in (i) the nonaqueous electrolyte secondary battery member and (ii) the nonaqueous electrolyte secondary battery is not limited to a particular one, provided that the positive electrode is one that is typically used in a nonaqueous electrolyte secondary battery. Examples of the positive electrode encompass a positive electrode sheet having a structure in which an active material layer, containing a positive electrode active material and a binding agent, is formed on an electrode current collector. The active material layer may further contain an electrically conductive agent.

Examples of the positive electrode active material encompass materials capable of being doped with and dedoped of lithium ions. Specific examples of such materials encompass lithium complex oxides each containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents can be used in combination.

Examples of the binding agent encompass (i) fluorine-based resins such as polyvinylidene fluoride, (ii) acrylic resin, and (iii) styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

Examples of a method for producing the positive electrode in sheet form encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) then, a positive electrode current collector is coated with the paste, and (iii) subsequently, the paste is dried and then pressured so that the paste is firmly fixed to the positive electrode current collector.

2. Negative Electrode

The negative electrode included in (i) the nonaqueous electrolyte secondary battery member and (ii) the nonaqueous electrolyte secondary battery is not limited to a particular one, provided that the negative electrode is one that is typically used in a nonaqueous electrolyte secondary battery. Examples of the negative electrode encompass a negative electrode sheet having a structure in which an active material layer, containing a negative electrode active material and a binding agent, is formed on an electrode current collector. The active material layer may further contain an electrically conductive agent.

Examples of the negative electrode active material encompass (i) materials capable of being doped with and dedoped of lithium ions, (ii) a lithium metal, and (iii) a lithium alloy. Examples of the materials capable of being doped with and dedoped of lithium ions encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in a lithium secondary battery and is easily processed into a thin film.

Examples of a method for producing the negative electrode in sheet form encompass: a method in which a negative electrode active material is pressure-molded on a negative electrode current collector; and a method in which (i) a negative electrode active material is formed into a paste with the use of a suitable organic solvent, (ii) then, a negative electrode current collector is coated with the paste, and (iii) subsequently, the paste is dried and then pressured so that the paste is firmly fixed to the negative electrode current collector. The paste preferably contains the electrically conductive agent and the binding agent.

3. Nonaqueous Electrolyte

A nonaqueous electrolyte in the nonaqueous electrolyte secondary battery is not limited to any particular one, provided that the nonaqueous electrolyte is one that is generally used for a nonaqueous electrolyte secondary battery. The nonaqueous electrolyte can be one prepared by, for example, dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent to be contained in the nonaqueous electrolyte encompass carbonates, ethers, esters, nitriles, amides, carbamates, and sulfur-containing compounds, and fluorine-containing organic solvents each obtained by introducing a fluorine group into any of these organic solvents. It is possible to use only one kind of the above organic solvents or two or more kinds of the above organic solvents in combination.

### EXAMPLES

The following description will discuss embodiments of the present invention in greater detail with reference to Examples and Comparative Examples. Note, however, that the present invention is not limited to the following Examples and Comparative Examples below.

[Measurement Methods]

The methods described below were used to measure physical properties and the like of the porous films and the nonaqueous electrolyte secondary battery laminated separators (hereinafter referred to as “laminated porous films”) produced in Examples 1 to 4 and in Comparative Examples 1 and 2.

[Film Thickness]

The film thickness of the porous films and the laminated porous films were measured with the use of a high-precision digital measuring device (VL-50) manufactured by Mitutoyo Corporation.

[Weight Per Unit Area]

From the laminated porous film, a square piece measuring 8 cm×8 cm was cut out as a sample, and the weight W (g) of the sample was measured. The following formula (2) was then used to calculate the weight per unit area of the laminated porous film.

Weight per unit area (g/m²)=W/(0.08×0.08) (2)

In a similar method, the weight per unit area of the porous film that is a member included in the laminated porous film was calculated. Thereafter, the weight per unit area of a para-aramid layer that is a member included in the laminated porous film was calculated by subtracting the weight per unit area of the porous film from the weight per unit area of the laminated porous film.

[Air Permeability]

The air permeability (Gurley value) of the laminated porous film was measured in conformance with JIS P8117.

[Puncture Strength]

The puncture strength of the laminated porous film was measured by a method including the following steps (i) and (ii):

(i) The laminated porous film was fixed on an upper surface of a stage with a washer having a diameter of 11.3 mm, and thereafter a pin (diameter of 1 mm; tip radius of 0.5R) was thrust into the laminated porous film at a speed of 10 mm/sec to a depth of 200 mm.

(ii) The maximum stress (gf) occurring when the pin was thrust into the laminated porous film in the step (i) was measured, and the measured value was considered to be the puncture strength of the laminated porous film.

[MD Breaking Elongation Ratio, TD Breaking Elongation Ratio]

The MD breaking elongation ratio and the TD breaking elongation ratio of the laminated porous film were measured in conformance with the JIS K7127 standard. Specifics of the measurement method are as follows.

The length of the laminated porous film in the MD was measured. The length of the laminated porous film in the MD thus measured is referred to hereinafter as the “MD length prior to elongation”. Thereafter, the laminated porous film was elongated in the MD, and the length of the laminated porous film in the MD at the time the laminated porous film broke was determined. The length of the laminated porous film in the MD at the time of breaking is referred to hereinafter as the “MD length after elongation”. The MD breaking elongation ratio was then found using the following formula (3):

MD breaking elongation ratio [% GL]=[{(MD length after elongation)−(MD length prior to elongation)}/(MD length prior to elongation)]×100 (3)

The length of the laminated porous film in the TD was measured in a similar manner. The length of the laminated porous film in the TD thus measured is referred to hereinafter as the “TD length prior to elongation”. Thereafter, the laminated porous film was elongated in the TD, and the length of the laminated porous film in the TD at the time the laminated porous film broke was determined. The length of the laminated porous film in the TD at the time of breaking is referred to hereinafter as the “TD length after elongation”. The TD breaking elongation ratio was then found using the following formula (4):

TD breaking elongation ratio [% GL]=[{(TD length after elongation)}−(TD length prior to elongation)}/(TD length prior to elongation)]×100 (4)

[Simple Impact Test]

From the laminated porous film, a square piece measuring 5 cm×5 cm was cut out as a sample, and the sample was attached to a square sheet made of polyurethane, measuring 5 cm×5 cm, and having a thickness of 5 mm (manufactured by Daiso Industries Co., Ltd.; earthquake-resistant mat, square type). A glass sphere (manufactured by Daiso Industries Co., Ltd.; glass pearl bead) having a diameter of 1.2 cm and a weight of 2.2 g was left still in the center of the sample attached to the sheet, and a cylindrical weight weighing 148 g and having a bottom surface 2.2 cm in diameter was freely dropped from a height of 35 cm, so that the weight collided with the glass sphere. At that time, the presence or absence of breakage of the sample was observed, and a case where the sample did not break was evaluated as “Pass”, and a case where the sample did break was evaluated as “Fail”. The test was carried out four times in total. Note that a new sample was prepared for each test, even when a sample used in a previous test did not break.

[(200) Plane Peak Area Ratio R]

First, wide-angle X-ray diffraction (WAXD) measurement with respect to the porous film was carried out by use of NANO-Viewer manufactured by Rigaku Corporation (X-ray output: Cu target, 40 kV, 20 mA). A (200) plane peak area ratio R of a polyethylene crystal of a laminated porous film was evaluated based on an area ratio between the obtained crystal peaks of the polyethylene.

Specifically, the (200) plane peak area ratio R was calculated by the following method. That is, first, assuming that an MD of a sample of the laminated porous film was a vertical direction, the sample was mounted to a sample holder, and the surface of the sample was irradiated with an X-ray from the vertical direction of the sample, so that a WAXD diagram was obtained.

Next, for a peak on a (110) plane of polyethylene which peak appeared in the vicinity of a diffraction angle 2θ=21 degrees, an azimuthal profile was calculated assuming that a horizontal direction was at an azimuth angle β=0 degree. A diffraction intensity profile with respect to the diffraction angle 2θ was found at an azimuth angle β of ±5 degrees around the most intense peak that appeared in the vicinity of β=0 degree in the azimuthal profile.

In the obtained diffraction intensity profile, areas I(110) and I(200) of peaks on (110) and (200) planes of polyethylene were found, wherein the peaks were detected at the diffraction angle 2θ being in the vicinity of 21 degrees and 24.5 degrees. Further, the (200) plane peak area ratio R was calculated by the following equation (1):

(200) plane peak area ratio R=I(200)/I(110) (1)

### Example 1

First, prepared was a mixture containing: 70% by weight of ultra-high molecular weight polyethylene powder (intrinsic viscosity of 21 dL/g; viscosity average molecular weight: 3,000,000; manufactured by Tosoh Corporation); and 30% by weight of a polyethylene wax having a weight-average molecular weight of 2,000 (EXCEREX 20700, manufactured by Mitsui Chemicals, Inc.). Then, 0.4 parts by weight of an antioxidant (IRGANOX 1010, manufactured by BASF), 0.1 parts by weight of an antioxidant (IRGAFOS 168, manufactured by BASF), and 1.3 parts by weight of sodium stearate were added to 100 parts by weight of the mixture of (i) the ultra-high molecular weight polyethylene and (ii) the polyethylene wax, so as to obtain a second mixture.

Then, calcium carbonate having an average particle diameter of 0.1 μm (manufactured by Maruo Calcium Co., Ltd.) was added to the second mixture such that the volume of the calcium carbonate was 38% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained.

A pair of rollers was used to stretch the polyolefin resin composition in the MD to a stretch ratio of 1.4 times, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained.

Then, TD-wise ends of the primary sheet thus obtained were each held by a plurality of holding members that were arranged so as to be adjacent in the MD. The primary sheet was stretched in the TD to a stretch ratio of 4.29 times, so that a secondary sheet was obtained.

Next, TD-wise ends of the secondary sheet were each held by a plurality of holding members that were arranged so as to be adjacent in the MD. Further, the secondary sheet was stretched at a temperature of 115° C. in the TD to a stretch ratio of 1.63 times by increasing the distance between holding members that were opposite each other in the TD. At the same time, the secondary sheet was relaxed in the MD by decreasing the distance between the holding members that were adjacent in the MD. The secondary sheet was continuously shrunk in the TD until the stretch ratio became 1.4 times, so that a porous film having a film thickness of 13.8 μm was obtained. At this time, an MD relaxation ratio was 25%.

Then, with use of a 3-liter separable flask having a stirring blade, a thermometer, a nitrogen incurrent canal, and a powder addition port, poly(paraphenylene terephthalamide) was produced.

First, the separable flask was sufficiently dried, 2200 g of N-methyl-2-pyrrolidone (NMP) was put in the flask. Next, 151.07 g of calcium chloride powder that had been vacuum-dried at 200° C. for 2 hours was added to the NMP, and then the calcium chloride powder was completely dissolved in the NMP while a temperature inside the separable flask was raised to 100° C.

The temperature was brought down to a room temperature, and then 68.23 g of paraphenylenediamine was added to and completely dissolved in a resultant mixture. While a temperature of a resultant solution was maintained at 20° C.±2° C., 124.97 g of dichloride terephthalate, which was separated into 5 pieces, was one-by-one added to the solution at approximately 10-minute intervals. After that, a resultant solution was ripened for 1 hour while being stirred and maintained at 20° C.±2° C. The solution thus ripened was filtered through 1500-mesh stainless steel gauze. A para-aramid solution thus obtained had a para-aramid concentration of 6% by weight.

The para-aramid solution thus obtained was weighed by 100 g and put in a flask. Then, 158 g of NMP was added to the solution. Thus, a para-aramid solution having a para-aramid concentration of 2.25% by weight was prepared. Then, the solution thus prepared was stirred for 10 minutes. Into the solution having a para-aramid concentration of 2.25% by weight, 6 g of alumina C (manufactured by NIPPON AEROSIL CO., LTD.; average primary diameter: 13 nm) and 2.3 g of calcium carbonate (manufactured by Maruo Calcium Co., Ltd.) were mixed, so that a coating liquid was obtained.

After the porous film was coated with the coating liquid thus obtained, the coating liquid was dried to form a para-aramid layer (porous layer) on the porous film. As a result, a laminated porous film in which the para-aramid layer was formed on the porous film was obtained. The weight per unit area of the para-aramid layer was 1.9 g/m².

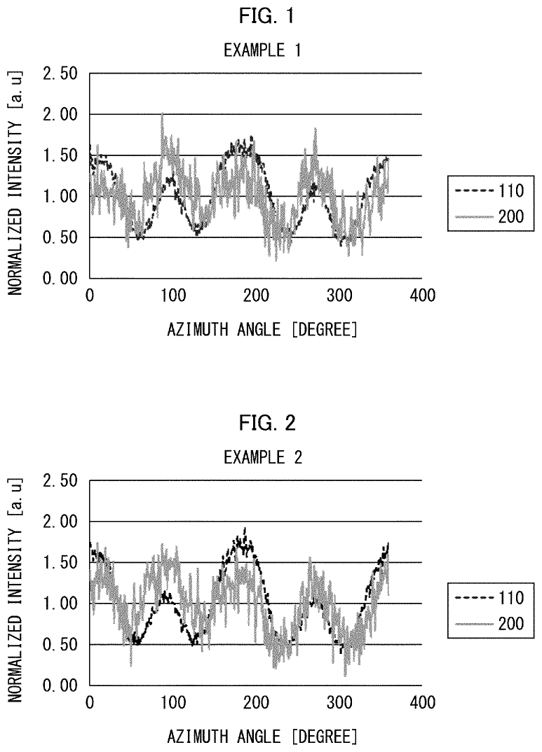

Physical properties and the like of the laminated porous film thus obtained (nonaqueous electrolyte secondary battery laminated separator) were measured by the methods described above. The results are shown in Tables 1 and 2. Further, FIG. 1 shows a diffraction intensity profile of the laminated porous film obtained by the method described above.

Note that the “MD relaxation ratio” refers to a rate of decrease of the length of the porous film in the MD with respect to the length of the secondary sheet in the MD before stretching.

### Example 2

A primary sheet was obtained by the same method as the method for obtaining the primary sheet in Example 1. Thereafter, the primary sheet thus obtained was stretched in the TD to a stretch ratio of 3.57 times by the same method as in Example 1, so that a secondary sheet was obtained.

TD-wise ends of the secondary sheet were each held by a plurality of holding members that were arranged so as to be adjacent in the MD. Then, the secondary sheet was stretched at a temperature of 110° C. in the TD to a stretch ratio of 1.4 times by increasing the distance between holding members that were opposite each other in the TD. At the same time, the secondary sheet was relaxed in the MD by decreasing the distance between the holding members that were adjacent in the MD. As a result, a porous film having a film thickness of 14.1 μm was obtained. At this time, an MD relaxation ratio was 25%.

With use of the porous film thus obtained, a laminated porous film was obtained by forming a para-aramid layer on the porous film by the same method as the method for obtaining the laminated porous film in Example 1. The weight per unit area of the para-aramid layer was 1.7 g/m².

Physical properties and the like of the laminated porous film thus obtained (nonaqueous electrolyte secondary battery laminated separator) were measured by the methods described above. The results are shown in Tables 1 and 2. Further, FIG. 2 shows a diffraction intensity profile of the laminated porous film obtained by the method described above.

### Example 3

A primary sheet was obtained by the same method as the method for obtaining the primary sheet in Example 1. Thereafter, the primary sheet thus obtained was stretched in the TD to a stretch ratio of 4.29 times by the same method as in Example 1, so that a secondary sheet was obtained.

TD-wise ends of the secondary sheet were each held by a plurality of holding members that were arranged so as to be adjacent in the MD. Then, the secondary sheet was stretched at a temperature of 115° C. in the TD to a stretch ratio of 1.4 times by increasing the distance between holding members that were opposite each other in the TD. At the same time, the secondary sheet was relaxed in the MD by decreasing the distance between the holding members that were adjacent in the MD. As a result, a porous film having a film thickness of 14.1 μm was obtained. At this time, an MD relaxation ratio was 25%.

With use of the porous film thus obtained, a laminated porous film was obtained by forming a para-aramid layer on the porous film by the same method as the method for obtaining the laminated porous film in Example 1. The weight per unit area of the para-aramid layer was 2.1 g/m².

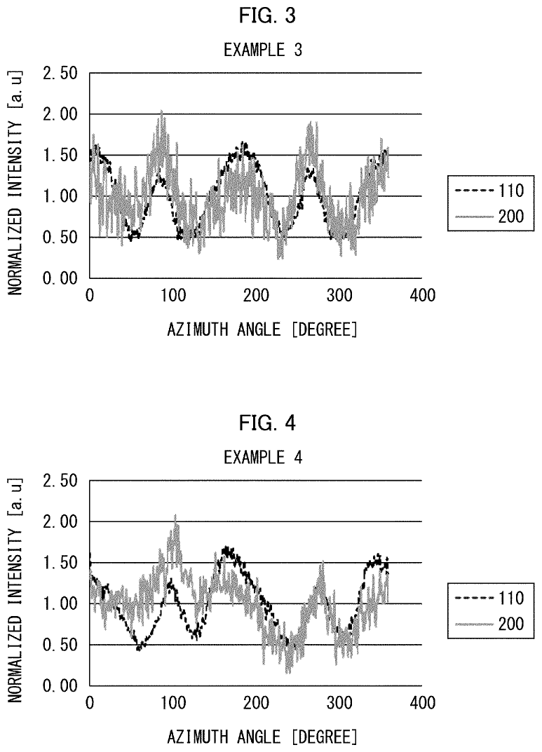

Physical properties and the like of the laminated porous film thus obtained (nonaqueous electrolyte secondary battery laminated separator) were measured by the methods described above. The results are shown in Tables 1 and 2. Further, FIG. 3 shows a diffraction intensity profile of the laminated porous film obtained by the method described above.

### Example 4

A secondary sheet was obtained by the same method as the method for obtaining the secondary sheet in Example 2. Except that the temperature at which the secondary sheet thus obtained was stretched was set to 115° C., a porous film having a film thickness of 14.1 μm was obtained, by the same method as in Example 2, by stretching the secondary sheet in the TD while the secondary sheet was relaxed in the MD.

With use of the porous film thus obtained, a laminated porous film was obtained by forming a para-aramid layer on the porous film by the same method as the method for obtaining the laminated porous film in Example 1. The weight per unit area of the para-aramid layer was 1.9 g/m².

Physical properties and the like of the laminated porous film thus obtained (nonaqueous electrolyte secondary battery laminated separator) were measured by the methods described above. The results are shown in Tables 1 and 2. Further, FIG. 4 shows a diffraction intensity profile of the laminated porous film obtained by the method described above.

### Comparative Example 1

First, prepared was a mixture containing: 68% by weight of ultra-high molecular weight polyethylene powder (GUR2024, manufactured by Ticona); and 32% by weight of a polyethylene wax having a weight-average molecular weight of 1,000 (FNP-0115, manufactured by Nippon Seiro Co., Ltd.). Then, 0.4 parts by weight of an antioxidant (IRGANOX 1010, manufactured by BASF), 0.1 parts by weight of an antioxidant (IRGAFOS 168, manufactured by BASF), and 1.3 parts by weight of sodium stearate were added to 100 parts by weight of the mixture of (i) the ultra-high molecular weight polyethylene and (ii) the polyethylene wax, so as to obtain a second mixture.

Then, calcium carbonate having an average particle diameter of 0.1 μm (manufactured by Maruo Calcium Co., Ltd.) was added to the second mixture such that the volume of the calcium carbonate was 38% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained.

The polyolefin resin composition was stretched in the MD to a stretch ratio of 1.4 times by a pair of rollers, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained.

Then, TD-wise ends of the primary sheet thus obtained were each held by a plurality of holding members that were arranged so as to be adjacent in the MD. Next, the primary sheet was stretched at 123° C. in the TD to a stretch ratio of 7.05 times, so that a porous film having a film thickness of 13.5 μm was obtained.

With use of the porous film thus obtained, a laminated porous film was obtained by forming a para-aramid layer on the porous film by the same method as the method for obtaining the laminated porous film in Example 1. The weight per unit area of the para-aramid layer was 3.0 g/m².

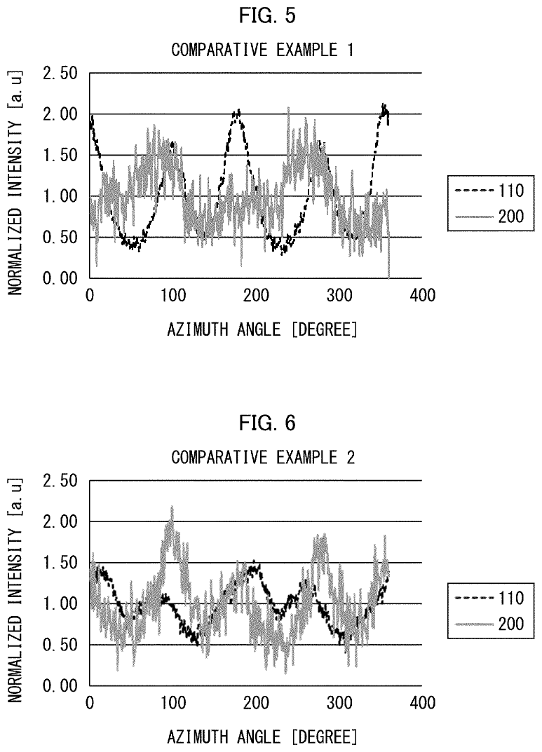

Physical properties and the like of the laminated porous film thus obtained (nonaqueous electrolyte secondary battery laminated separator) were measured by the methods described above. The results are shown in Tables 1 and 2. Further, FIG. 5 shows a diffraction intensity profile of the laminated porous film obtained by the method described above.

### Comparative Example 2

The procedure was carried out in the same manner as in Example 1 until a primary sheet was obtained, and then TD-wise ends of the primary sheet thus obtained were each held by a plurality of holding members that were arranged so as to be adjacent in the MD.

Then, the primary sheet was stretched in the TD to a stretch ratio of 5 times by increasing the distance between holding members that were opposite each other in the TD. At the same time, the primary sheet was relaxed in the MD by decreasing the distance between the holding members that were adjacent in the MD. As a result, a porous film having a film thickness of 14.0 μm was obtained. At this time, an MD relaxation ratio was 20%.

With use of the porous film thus obtained, a laminated porous film was obtained by forming a para-aramid layer on the porous film by the same method as the method for obtaining the laminated porous film in Example 1. The weight per unit area of the para-aramid layer was 1.7 g/m².

Physical properties and the like of the laminated porous film thus obtained (nonaqueous electrolyte secondary battery laminated separator) were measured by the methods described above. The results are shown in Tables 1 and 2. Further, FIG. 6 shows a diffraction intensity profile of the laminated porous film obtained by the method described above.

[Results]

TABLE 1

| | Porous film | Laminated porous film | | |
|---|---|---|---|---|
| | Film | Film | Puncture | Air |
| | thickness | thickness | strength | permeability |
| | [μm] | [μm] | [N] | [sec/100 mL] |
| Example 1 | 13.8 | 16.6 | 5.5 | 197 |
| Example 2 | 14.1 | 16.0 | 5.1 | 257 |
| Example 3 | 14.1 | 16.5 | 5.5 | 241 |
| Example 4 | 14.1 | 15.6 | 5.3 | 185 |
| Comparative | 13.5 | 16.5 | 4.8 | 122 |
| Example 1 | | | | |
| Comparative | 14.0 | 17.3 | 3.8 | 242 |
| Example 2 | | | | |

TABLE 2

| | Laminated porous film | | | | | |
|---|---|---|---|---|---|---|
| | | TD breaking | Results of simple | | | |
| | 200 plane | elongation | impact test | | | |
| | peak area | ratio | Number of times | | | |
| | ratio R | [% GL] | 1 | 2 | 3 | 4 |
| Example 1 | 0.150 | 187 | Pass | Pass | Pass | Fail |
| Example 2 | 0.152 | 252 | Pass | Pass | Pass | Fail |
| Example 3 | 0.159 | 175 | Pass | Pass | Pass | Fail |
| Example 4 | 0.196 | 238 | Pass | Pass | Pass | Fail |
| Comparative | 0.125 | 206 | Pass | Fail | Fail | Fail |
| Example 1 | | | | | | |
| Comparative | 0.144 | 126 | Fail | Fail | Fail | Fail |
| Example 2 | | | | | | |

As shown in Table 2, the nonaqueous electrolyte secondary battery laminated separators in Examples 1 to 4 had the (200) plane peak area ratio R of not less than 0.15, and the nonaqueous electrolyte secondary battery laminated separators in Comparative Examples 1 and 2 had the (200) plane peak area ratio R of less than 0.15. The nonaqueous electrolyte secondary battery laminated separators in Examples 1 to 4 are less likely to break in the simple impact test than the nonaqueous electrolyte secondary battery laminated separators in Comparative Examples 1 and 2.

Thus, it was found that the nonaqueous electrolyte secondary battery separator in accordance with an embodiment of the present invention has excellent impact resistance due to having the (200) plane peak area ratio R of not less than 0.15.

### INDUSTRIAL APPLICABILITY

An aspect of the present invention can be suitably used in producing a nonaqueous electrolyte secondary battery.

1. A nonaqueous electrolyte secondary battery separator comprising:
a polyolefin porous film,
the nonaqueous electrolyte secondary battery separator having a (200) plane peak area ratio R of not less than 0.15, the (200) plane peak area ratio R being calculated, from a diffraction intensity profile obtained by wide-angle X-ray diffraction (WAXD) measurement, by the following formula (1):
(200) plane peak area ratio R=I(200)/I(110) (1)
wherein the WAXD is carried out by irradiating a surface of the nonaqueous electrolyte secondary battery separator with an X-ray from a direction vertical to the surface of the nonaqueous electrolyte secondary battery separator, I(110) is a peak area of a diffraction peak on a (110) plane of the diffraction intensity profile, and I(200) is a peak area of a diffraction peak on a (200) plane of the diffraction intensity profile.

2. The nonaqueous electrolyte secondary battery separator according to claim 1, further comprising:
a porous layer containing a resin,
the porous layer being formed on one surface or on both surfaces of the polyolefin porous film.

3. The nonaqueous electrolyte secondary battery separator according to claim 2, wherein the resin is at least one kind of resin selected from the group consisting of polyolefins, (meth)acrylate-based resins, fluorine-containing resins, polyamide-based resins, polyester-based resins, and water-soluble polymers.

4. The nonaqueous electrolyte secondary battery separator according to claim 2, wherein the resin is an aramid resin.

5. The nonaqueous electrolyte secondary battery separator according to claim 1, wherein the polyolefin porous film has a puncture strength of not less than 5.0 N.

6. A nonaqueous electrolyte secondary battery member comprising:
a positive electrode;
the nonaqueous electrolyte secondary battery separator according to claim 1; and
a negative electrode,
the positive electrode, the nonaqueous electrolyte secondary battery separator, and the negative electrode being arranged in this order.

7. A nonaqueous electrolyte secondary battery comprising:
the nonaqueous electrolyte secondary battery separator according to claim 1.
